(19) United States
(12) Patent Application Publication
(10) Pub. No.: US 2025/0148153 A1
(43) Pub. Date: May 8, 2025

(54) METHOD OF MODELLING ENGINEERING DESIGN COMPONENTS

(71) Applicant: Siemens Industry Software Inc., Plano, TX (US)

(72) Inventors: Douglas King, Cambridge (GB); Howard Mattson, Cambridge (GB); Yanong Zhu, Cambridge (GB); Michael Copley-May, Cambridge (GB)

(21) Appl. No.: 18/837,520

(22) PCT Filed: Feb. 25, 2022
(86) PCT No.: PCT/US2022/017829

§ 371 Date: Aug. 9, 2024

(51) Int. Cl. G06F 30/17

(52) U.S. Cl. CPC G06F 30/17

(57) ABSTRACT

A computer-implemented method of modelling engineering design components in a Computer-Aided Design (CAD) system is disclosed, wherein an engineering design component includes a feature having at least three occurrences of a shape element arranged in a regular pattern. The method is split into three stages: definition of a core set of behavioral characteristics; definition of an optional set of behavioral characteristics; and a hierarchical implementation of the optional characteristics by solving optional constraints after constraints corresponding to the core behavioral characteristics have been solved.

The present patent document is a § 371 nationalization of PCT Application Serial No. PCT/US2022/017829, filed Feb. 25, 2022, designating the United States, which is incorporated by reference in its entirety.

### TECHNICAL FIELD

The disclosure relates to a computer-implemented method of modelling engineering design components in a Computer-Aided Design (CAD) system, wherein an engineering design component includes a feature having at least three occurrences of a shape element arranged in a regular pattern.

### BACKGROUND

Regular and repeated shapes are commonplace in the design of everyday objects, and may feature in engineering designs and design components. For example, rectangular grid arrangements are used frequently in the design of ventilation or heat-exchange systems, such as grills and cooling systems, and circular and linear arrangements are found in fixings and mountings. In order to allow engineers to carry out design and testing of products, these collections of regular shapes are modelled in two-dimensional (2D) and three-dimensional (3D) CAD systems and may be referred to as patterns. Patterns are made up of occurrences, each of which are the same shape element, with the occurrences then arranged to form the pattern. These arrangements may be in a rectangular or circular form, with the individual occurrences being either in 2D or 3D. Both the repeated shape of the occurrences and the arrangement of the occurrences may be represented in constraint-based modelling systems. When the model is edited or changed by a user of the CAD system, there are many freedoms for a solver to change as the constraint system needs to be solved for the change to take place. As an example, the freedoms available in a simple rectangular pattern may be considered to be as follows: the shape of the occurrence; the X, Y, and Z directions of the pattern; the X, Y, and Z spacing of the occurrences; the X, Y, and X count of occurrences; and the position of the pattern.

With such a variety of freedoms available for change, it may be difficult for the user to control the behavior of the freedoms when the model is changed or edited.

There are three used approaches to control these freedoms. Firstly, the user may be asked to constrain the model manually, so that the pattern behaves as they desire during an edit or change. This may be achieved by the addition of dimensions. While this approach will define the behavior of the patterns, it may be time-consuming and forces the user to decide in advance how the pattern may be edited or changed later in the design process. For users in the conceptual phase of design development, being asked to take such decisions is inappropriate, because the design is still open to what may be a considerable change.

Secondly, the software of the CAD system may attempt to constrain the model on behalf of the user automatically. To do this, the software attempts to add the constraints and dimensions that the user would have created manually, as the pattern is formed or during post-processing. This approach saves the user time and defines the behavior of the patterns, but inevitably makes assumptions about how the pattern is to be used later in the design process that may or may not be correct. Again, this leads to the pattern being fully defined, which, as in the first case above, is not suitable for users in a conceptual phase of design development and may make performing some simple edits or changes more difficult than if the pattern were not fixed.

Thirdly, the software of the CAD system may attempt to add or remove constraints depending on the user's interaction with the model. In this situation, the software will attempt to add or remove constraints to the pattern depending on how the user attempts to edit the pattern, either directly to the pattern itself, or on a wider basis via model edits. For example, if a user selects one entity in an occurrence, such as a face, it may be assumed that this is an attempt to edit the shape of the occurrences. The system may then lock all the other freedoms in the pattern except for the shape of the occurrences to give the correct behavior. Or, if the user selects all entities in an occurrence, it may be assumed that they are trying to change the spacing between the occurrences, and freedoms that are unrelated to this edit may be locked. This approach has obvious advantages over the first and second cases above. It avoids the necessity of having the user or the CAD system software fully define the pattern upfront to control behavior and makes the edits that the user is attempting the driver for the required constraint scheme controlling the behavior, so is more flexible. However, beyond the obvious edits a user may wish to make on simple patterns the logic to determine behavior may become extremely complex. In reality, 2D and 3D models for real engineering applications become complex very quickly and such a system is prone to making incorrect assumptions, resulting in an inability for a user to make their desired changes. It would therefore be desirable to be able to find a way to deal with all of the freedoms that a solver needs to change on editing of a model by a user that may be implemented easily at all stages in the design process.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The present disclosure aims to address these issues by providing, in a first aspect, a computer-implemented method of modelling engineering design components in a Computer-Aided Design (CAD) system, wherein an engineering design component includes a feature having at least three occurrences of a shape element arranged in a regular pattern. The computer-implemented method includes: defining a core set of geometric characteristics of the occurrences of the shape element in the feature and the spatial relationships between the occurrences of the shape element in the regular pattern, wherein each geometric characteristic and spatial relationship is associated with a constraint determining the behavior of the occurrence of the shape element when changed; defining a set of optional geometric characteristics of the occurrences of the shape element in the feature and the spatial relationships between the occurrences of the shape element in the regular pattern, wherein each optional geometric characteristic and spatial relationship is associated with an optional constraint determining the behavior of the occurrence of the shape element when changed; defining a hierarchical order for the set of optional geometric characteristics and spatial relationships and their associated optional constraints; receiving a change in the occurrences of the shape element and/or the regular pattern from a user, the change being carried out by: i) solving the constraints associated with the core set of geometric characteristics and spatial relationships; ii) solving the optional constraints associated with the set of optional geometric characteristics and spatial relationships in the hierarchical order in which these are defined; and e) displaying the changed occurrences of the shape element and/or the regular pattern to the user.

By utilizing a combination of core behavior characteristics and associated constraints, optional behavior characteristics and associated optional constraints, with the latter defined and executed, when required, in a hierarchical order, the issues surrounding implementing all freedoms a solver may encounter at any stage of the design process of an engineering product seen in other methods are overcome.

In one embodiment, if a change includes selecting all of the occurrence, then the coordinate system of the occurrence may be added to the selection.

In one embodiment, an occurrence of a shape element may include a boundary, and the boundary may be excluded from the definition of the core set of geometric characteristics and spatial relationships.

In one embodiment, the method may further include designating a single occurrence of a shape element in the pattern as the principal occurrence changing the shape or position of all of the occurrences by changing the shape or position of the principal occurrence.

The hierarchical order of the optional constraints associated with the set of optional geometric characteristics and spatial relationships may be the order of the implementation of the optional set of geometric characteristics and spatial relationships. In certain examples, the hierarchical order of the optional constraints associated with the set of optional geometric characteristics and spatial relationships may be given by: maintaining the direction of patterns and/or the center of patterns as a constant; maintaining the position of an occurrence of a shape element while its shape is changed; maintaining at least a portion of the shape of an occurrence of a shape element; maintaining the radius of a circular pattern; maintaining the position of a principal occurrence of a shape element; maintaining the spacing of a pattern as a constant; and maintaining the position of an occurrence of a shape element in a circular pattern relative to the center of the circular pattern as a constant. The order of implementation of a constraint may be determined by its effect on subsequently implemented constraints.

The occurrences of the shape element and/or the regular pattern may be in two-dimensions. Alternatively, the occurrences of the shape element and/or the regular pattern may be in three-dimensions.

The occurrences of the shape element may be mechanical, electrical, or thermal components in a product.

In a second aspect, a computer program containing instructions is provided, which, when executed by a computer, cause the computer to carry out the acts of the method outlined above.

In a third aspect, the a data processing system configured to model engineering design components in a Computer-Aided Design (CAD) system is provided, wherein an engineering design component includes a feature having at least three occurrences of a shape element arranged in a regular pattern. The data processing system includes a data processor configured to: define a core set of geometric characteristics of the occurrences of the shape element in the feature and the spatial relationships between the occurrences of the shape element in the regular pattern, wherein each geometric characteristic and spatial relationship is associated with a constraint determining the behavior of the occurrence of the shape element when changed; define a set of optional geometric characteristics of the occurrences of the shape element in the feature and the spatial relationships between the occurrences of the shape element in the regular pattern, wherein each optional geometric characteristic and spatial relationship is associated with an optional constraint determining the behavior of the occurrence of the shape element when changed; define a hierarchical order for the set of optional geometric characteristics and spatial relationships and their associated optional constraints; solve the constraints associated with the core set of geometric characteristics and spatial relationships; solve the constraints associated with the optional geometric characteristics and spatial relationships in the hierarchical order in which these are defined; and output the changed occurrences. The data processing system further includes a user input device configured to receive a change from a user. The data processing system further includes a display device configured to display the changed occurrences of the shape element and/or the regular pattern output by the data processor to the user.

### BRIEF DESCRIPTION OF THE DRAWINGS

The disclosure is now described by way of example only and with reference to the accompanying drawings, in which:

FIG. 1 illustrates an example of a data processing system in which an embodiment of the present disclosure may be implemented, for example a CAD system configured to perform processes as described herein;

FIG. 2 is a flowchart representing the acts in a method in accordance with the embodiments;

FIG. 3 outlines the process of act 212 of the method 200 in further detail;

FIG. 4a is a schematic representation of an example of a first pattern prior to a change being made to an occurrence of a shape element;

FIG. 4b is a schematic representation of an example of a first pattern after a change has been made to an occurrence of a shape element;

FIG. 5a is a schematic representation of an example of a second pattern prior to a change being made to an occurrence of a shape element;

FIG. 5b is a schematic representation of an example of a second pattern after a change has been made to an occurrence of a shape element;

FIG. 6a is a schematic representation of an example of a third pattern prior to a change being made to an occurrence of a shape element;

FIG. 6b is a schematic representation of an example of a third pattern after a change has been made to an occurrence of a shape element;

FIG. 7a is a schematic representation of an example of a fourth pattern prior to a change being made to an occurrence of a shape element;

FIG. 7b is a schematic representation of an example of a fourth pattern after a change has been made to an occurrence of a shape element;

FIG. 8a is a schematic representation of an example of a fifth pattern prior to a change being made to an occurrence of a shape element;

FIG. 8b is a schematic representation of an example of a fifth pattern after a change has been made to an occurrence of a shape element;

FIG. 9a is a schematic representation of an example of a sixth pattern prior to a change being made to an occurrence of a shape element;

FIG. 9b is a schematic representation of an example of a sixth pattern after a change has been made to an occurrence of a shape element; and

FIG. 10a is a schematic representation of an example of a seventh pattern prior to a change being made to an occurrence of a shape element; and

FIG. 10b is a schematic representation of an example of a seventh pattern after a change has been made to an occurrence of a shape element.

### DETAILED DESCRIPTION

The embodiments described below use the concept of defining a core set of geometric characteristics of the occurrences and an optional set of geometric characteristics, where the optional geometric characteristics are implemented using a set of optional constraints that are defined in a hierarchical order that determines their order of solving. A computer-implemented method of modelling engineering design components in a Computer-Aided Design (CAD) system is described in more detail below. The embodiments consider an engineering design component that includes a feature having at least three occurrences of a shape element. The shape element may be any 2D or 3D shape, which includes a plurality of entities. An entity may be a face, a vertex or an edge, each of which may be selected to move independently from all other entities in the shape element. The occurrences are arranged in a regular pattern, such as a circular or rectangular pattern, or even a linear array. Initially, the method defines a core set of geometric characteristics of the occurrences of the shape element in the feature and the spatial relationships between the occurrences of the shape element in the regular pattern. Each geometric characteristic and spatial relationship is associated with a constraint determining the behavior of the occurrence of the shape element when changed. Next, the method defines an optional set of geometric characteristics of the occurrences of the shape element in the feature and the spatial relationships between the occurrences of the shape element in the regular pattern. Each optional geometric characteristic and spatial relationship is associated with an optional constraint determining the behavior of the occurrence of the shape element when changed. Once the core and optional geometric characteristics and associated constraints have been defined, a hierarchical order for the optional set of geometric characteristics and spatial relationships and their associated optional constraints is defined. It is this hierarchical order that will determine the order in which the optional constraints are solved, following the solving of the constraints associated with the core set of geometric characteristics. Once this is done a user provides changes in the occurrences of the shape element and/or the regular pattern. This may be a change to an entity or the entire occurrence. The change is carried out by: i) solving the constraints associated with the core set of geometric characteristics and spatial relationships and then ii) solving the optional constraints associated with the optional geometric characteristics and spatial relationships in the hierarchical order in which these are defined. Finally, the changed occurrences of the shape element and/or the regular pattern are displayed to the user.

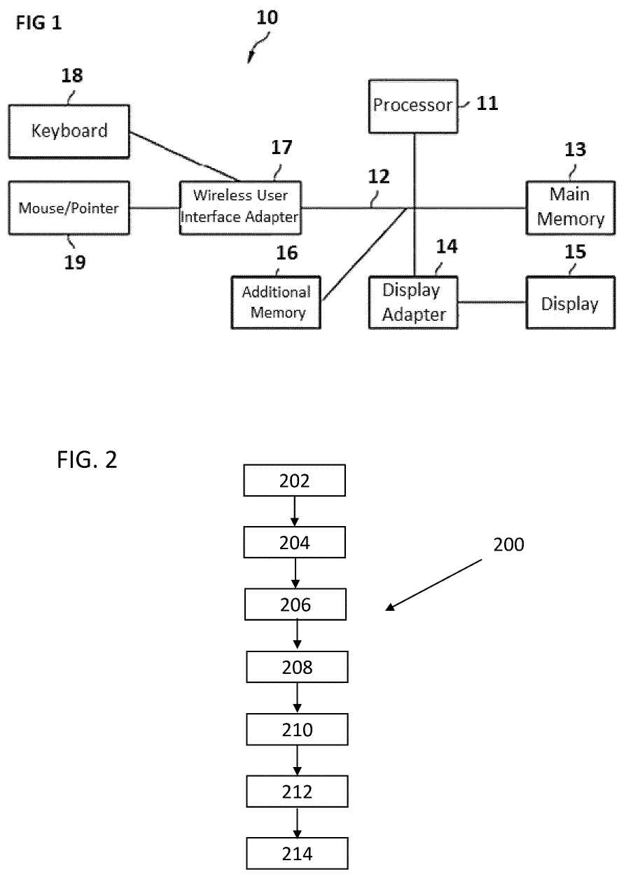

FIG. 1 illustrates an example of a data processing system in which an embodiment of the present disclosure may be implemented, for example, a CAD system configured to perform processes as described herein. The data processing system 10 includes a processor 11 connected to a local system bus 12. The local system bus connects the processor to a main memory 13 and graphics display adaptor 14, which may be connected to a display 15. The data processing system may communicate with other systems via a wireless user interface adapter connected to the local system bus 12, or via a wired network, e.g., to a local area network. Additional memory 16 may also be connected via the local system bus. A suitable adaptor, such as wireless user interface adapter 17, for other peripheral devices, such as a keyboard 18 and mouse 19, or other pointing device, allows the user to provide input to the data processing system. Other peripheral devices may include one or more I/O controllers such as USB controllers, Bluetooth controllers, and/or dedicated audio controllers (connected to speakers and/or microphones). Various peripherals may be connected to the USB controller (e.g., via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, devices referred to as input devices or output devices may both provide inputs and receive outputs of communications with the data processing system. Further, other peripheral hardware connected to the I/O controllers may include any type of device, machine, or component that is configured to communicate with a data processing system.

An operating system included in the data processing system enables an output from the system to be displayed to the user on display 15 and the user to interact with the system. Examples of operating systems that may be used in a data processing system may include Microsoft Windows™, Linux™, UNIX™, iOS™, and Android™ operating systems.

In addition, the data processing system 10 may be implemented as in a networked environment, distributed system environment, virtual machines in a virtual machine architecture, and/or cloud environment. For example, the processor 11 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 10 may vary for particular implementations. For example, the data processing system 10 in this example may correspond to a computer, workstation, and/or a server. However, alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 10 may be connected to the network (not a part of data processing system 10), which may be any public or private data processing system network or combination of networks, as known to those of skill in the art, including the Internet. Data processing system 10 may communicate over the network with one or more other data processing systems such as a server (also not part of the data processing system 10). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network. The data processing system 10 is configured, by a software program, to carry out the method in accordance with the embodiments described below in more detail.

When considering how to deal with the issues of existing systems, the approach of embodiments may be split into three stages: definition of a core set of behavioral characteristics; definition of an optional set of behavioral characteristics; and a hierarchical implementation of the optional characteristics by solving optional constraints after constraints corresponding to the core behavioral characteristics have been solved. In the following examples, the occurrences of the shape element and/or the regular pattern are in two-dimensions. However, in a CAD system the occurrences of the shape element and/or the regular pattern may be in three-dimensions, to which the method of the embodiments apply equally. The shape elements themselves may be in two- or three-dimensions because these are found commonly in designs of engineering products for which CAD systems are employed as part of the design process. For example, the occurrences of the shape element may be mechanical, electrical, or thermal components in such an engineering product.

### 1. Core Set of Behavioral Characteristics

The core set of behavioral characteristics represented are those that are preserved before, during, and after a change. All core behavioral characteristics are implemented by a constraint during solving by the solver and should be regarded as being a fundamental requirement of the change. The core set of behavioral characteristics falls into two subsets, the first relating to size and shape, the second relating to the preservation of regular form. Therefore, the geometric characteristics of the occurrences of the shape element in a feature being designed as part of the model and the spatial relationships between the occurrences of the shape element in the regular pattern form these behavioral changes. Each geometric characteristic and spatial relationship is associated with a constraint determining the behavior of the occurrence of the shape element when changed, and these constraints cannot be broken.

a) All occurrences of a shape element in a pattern remain the same size and shape. If a pattern's occurrences are formed from a shape element including a number of entities (faces, vertices, edges) in the model, these entities represent the same shape element before, during, and after the change. It is acceptable for faces to be missing within an occurrence of a shape element, although this depends on the interface of the pattern with the wider model under development. It may be desirable for some changes to be able to exclude the boundary of each occurrence of a shape element from the definition, for example, if an occurrence of a shape element includes an internal structure. This may be envisaged, for example, in designing a production line containing identical workstations, where a user wishes to move items on the workstation but not the workstation itself, and to replicate this movement across all workstations. Hence, when an occurrence of a shape element includes a boundary, this boundary may be excluded from the definition of the core set of geometric characteristics and spatial relationships.

b) For patterns where the occurrence of a shape elements is arranged in a regular form, such as rectangular, circular, or linear patterns, this form should be preserved. Taking the example of a rectangular pattern, the arrangement of occurrences of a shape element continue to be defined by two directions, although these directions may change. The spacing are consistent between each occurrence of a shape element, but the value (the actual distance between each occurrence of a shape element) may change. The number of occurrences of a shape element should remain constant, unless a change to this is specified by the user as an exception or as part of the definition of the core behavioral characteristics.

The general methods for implementing such definitions employed in the embodiments are based on traditional constraint solving technology. However, in addition to this, logic is included such that when all entities of a shape element forming an occurrence of a shape element are selected for a change the occurrence of a shape element coordinate system is automatically added to this selection. This defines rigidity between all of the selected entities of the shape element and the coordinate system of the occurrence of a shape element. Each occurrence of the shape element within the pattern has its own coordinate system. For core behavioral characteristics therefore, any action that is applied to a single occurrence of a shape element of a shape element will be replicated uniformly and universally across all of the occurrences of a shape element. The core set of behavioral characteristics are constrained with regular constraints, which therefore cannot be broken, leading to the definition of a second set of behavioral characteristics that are optional.

### 2. Set of Optional Behavioral Characteristics

A set of optional geometric characteristics of the occurrences of the shape element in the feature and the spatial relationships between the occurrences of the shape element in the regular pattern are then defined. Each optional geometric characteristic and spatial relationship is associated with an optional constraint determining the behavior of the occurrence of the shape element when changed. This set of optional behavioral characteristics is defined in a hierarchical order in which the solver should attempt to solve the associated constraints. The hierarchical order of the optional constraints associated with the set of optional geometric characteristics and spatial relationships may be the order of the implementation of the optional set of geometric characteristics and spatial relationships. This is defined as follows, based upon the need to determine the order of implementation of a constraint by its effect on subsequently implemented constraints:

One constraint is maintaining the direction of patterns and/or the center of patterns as a constant. Any change may preserve the original direction of a pattern and/or the center of a pattern since any alteration of this is likely to have the greatest effect on subsequent behavior characteristics and their associated constraints.

Another constraint is maintaining the position of an occurrence while its shape is changed. Secondly, when the shape of an occurrence of a shape element is changed, it is important that this does not change the position of the actual occurrence of the shape element. For example, if a face of the shape element is moved, the remainder of the shape element should remain in its original position.

Another constraint is maintaining at least a portion of the shape of an occurrence. Next, it is desirable that at least a portion, and, e.g., as much as possible, of an occurrence of a shape element is preserved during a change. While moving a single face may require that its adjacent faces be altered, the remainder of the occurrence of a shape element should remain in its original form.

Another constraint is maintaining the radius of a circular pattern. Changing the radius of a circular pattern may affect the angle between occurrences of shape elements within the pattern and is therefore undesirable. This maintains the size of the pattern with respect to the overall model if the radius of the circular pattern is altered.

Another constraint is maintaining the position of a principal occurrence. The position of the principal occurrence is likely to be the basis of the initial pattern and maintaining this as stationary may be advantageous.

Another constraint is maintaining the spacing of a pattern as a constant. Maintaining the spacing of a pattern retains the characteristics of a design, however, to stipulate this as a requirement in preference to those listed above may be overly limiting in the overall context of the design and model.

Another constraint is maintaining the position of an occurrence in a circular pattern relative to the center of the circular pattern as a constant. By maintaining the position of an occurrence of a shape element relative to the center of a circular pattern, the rotation of the occurrence about this center point is prevented.

A single occurrence of a shape element in the pattern may be designated as the principal occurrence, such that a user only needs to change the principal occurrence for the change to be replicated across all of the occurrences in a pattern. The user may define the principal occurrence, which may be the first occurrence of the shape element to be created, replication of which formed the pattern initially. Alternatively, the principal occurrence may be defined automatically in the CAD system or earlier in the design process.

### 3. Hierarchical Implementation of the Optional Behavioral Characteristics

As mentioned above, the optional behavior characteristics are defined within the CAD system by the associated optional constraints. Each optional behavior characteristic is a geometric characteristic of the occurrences of the shape element in the feature being modelled or the spatial relationships between the occurrences of the shape element in the regular pattern that is associated with its own, optional, constraint. The hierarchy of the definition of the optional behavior characteristics determines their order of implementation, which is descending the hierarchy from the first defined optional behavior characteristic to the last. In addition, an optional constraint is only imposed if the system does not become over-defined once the constraint has been applied.

Taking the example of a rectangular pattern of occurrences of shape elements, having an x-axis and a y-axis lying perpendicular to one another and an origin where the axes meet, the optional behavior characteristics are implemented as follows: i) a fix-optional constraint on the x-axis of the pattern; ii) a fix-optional constraint on the y-axis of the pattern; iii) if there is a selection within an occurrence of a shape element, a fix-optional constraint on the coordinate system of the occurrence; iv) if a dimension of an entity on the principal occurrence of a shape element is being changed, a fix-optional constraint on the occurrence coordinate system; v) a rigid-optional constraint between each entity in the principal occurrence and its coordinate system, ordered by distance from the entities being changed; vi) a fix-optional constraint on the principal occurrence coordinate system; vii) a fix-spacing-optional constraint on the spacing value for the x-axis; and viii) a fix-spacing-optional constraint on the spacing value for the y-axis.

In a circular pattern, the x- and y-axes may be replaced with the axis of the circle defining the pattern

The method in accordance with embodiments is now outlined and illustrated with examples. FIG. 2 is a flowchart representing the acts in a method in accordance with the embodiments. The method 200 includes, in act 202, defining a core set of geometric characteristics of the occurrences of the shape element in the feature and the spatial relationships between the occurrences of the shape element in the regular pattern. Each geometric characteristic and spatial relationship is associated with a constraint determining the behavior of the occurrence of the shape element when changed.

At act 204, a set of optional geometric characteristics of the occurrences of the shape element in the feature and the spatial relationships between the occurrences of the shape element in the regular pattern are defined. Each optional geometric characteristic and spatial relationship is associated with an optional constraint determining the behavior of the occurrence of the shape element when changed.

At act 206, a hierarchical order for the set of optional geometric characteristics and spatial relationships and their associated optional constraints is defined.

At this point, at act 208, a change in the occurrences of the shape element and/or the regular pattern is received from a user.

At act 210, the change is carried out initially by solving the constraints associated with the core set of geometric characteristics and spatial relationships.

At act 212, the optional constraints associated with the set of optional geometric characteristics and spatial relationships are solved in the hierarchical order in which these are defined.

At act 214, the changed occurrences of the shape element and/or the regular pattern are displayed to the user. Optionally, a single occurrence of a shape element in the pattern as the principal occurrence may be designated. This means that the user is able to change the shape or position of all of the occurrences by changing the shape or position of the principal occurrence.

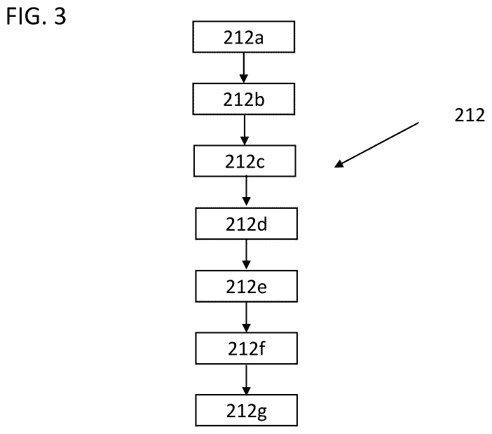

FIG. 3 outlines the process of act 212 of the method 200 in further detail. In this example, a constraint is only imposed, and the relevant sub-act is executed if the optional behavior characteristic requires implementation as a result of the change supplied by the user. In order to implement any required optional behavior characteristics, in act 212, the following sub-acts take place.

At act 212a, the direction of patterns and/or the center of patterns is maintained as a constant.

At act 212b, the position of an occurrence of a shape element is maintained while its shape is changed.

At act 212c, at least a portion of the shape of an occurrence of a shape element is maintained.

At act 212d, the radius of a circular pattern is maintained, if the pattern is circular.

At act 212e, the position of a principal occurrence of a shape element is maintained.

At act 212f, the spacing of a pattern is maintained as a constant.

At act 212g, the position of an occurrence of a shape element in a circular pattern is relative to the center of the circular pattern is maintained as a constant. Sub-acts corresponding to optional constraints that do not require solving in a particular change will be omitted, but subsequent sub-acts, if required, will continue to be executed in the hierarchical order. Some acts may need to be executed twice, but again, will remain executed in hierarchical order. Where the optional constraint relates to a rectangular pattern, the following sub-acts take place.

At act 212a, the direction of patterns and/or the center of patterns is maintained as a constant.

At act 212b, the position of an occurrence of a shape element is maintained while its shape is changed.

At act 212c, at least a portion of the shape of an occurrence of a shape element is maintained.

At act 212d, the relationship between entities in the occurrence of the shape element and its coordinate system is maintained, starting with a principal occurrence.

At act 212e, the position of a principal occurrence of a shape element is maintained.

At act 212f, the spacings of a pattern in the x- and y-directions are maintained.

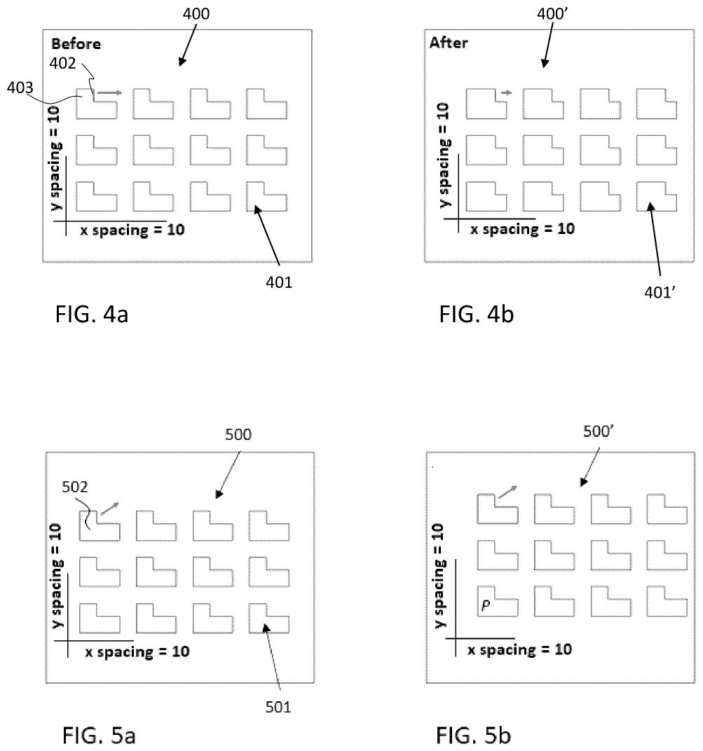

FIG. 4a is a schematic representation of a first pattern prior to a change being made to an occurrence of a shape element, and FIG. 4b is a schematic representation of a first pattern after a change has been made to an occurrence of a shape element.

In FIG. 4a, the pattern 400 includes twelve occurrences of a shape element 401 arranged in a four by three pattern uniformly on x- and y-axes. The origin O sits at the lower left-hand corner of the pattern 400. The horizontal spacing along the x-axis is given as 10 size units, and the vertical spacing along the y-axis is also given as 10 size units. The shape element 401 may be “L”-shaped and includes six edges. A user desires to move one of the edges 402 on the upright of the “L”-shape, and so choses to move this edge 402 on the occurrence 403 of the shape element 401 located at the lower right-hand corner of the pattern 400. In order for this move to occur, the method 200 is executed by the data-processing system 10, with the sub-acts in the process for implementing optional behavior characteristics as shown in Table 1 below, where a constraint is imposed if it is required by the change provided by the user. In this example, a change is applied to an occurrence of the shape element that is not the principal occurrence P.

TABLE 1
optional constraints for moving a single
edge in an occurrence of a shape element

| Sub- | | | |
|---|---|---|---|
| Act | Optional constraint | Imposed | Order |
| 212a | Fixedly constrain the x-axis | Yes | 1 |
| 212b | Fixedly constrain the y-axis | Yes | 2 |
| 212c | Fixedly constrain the occurrence | Yes | 3 |
| | coordinate system of the selected | | |
| | occurrence 403 of the shape element 401 | | |
| 212d | Rigidly constrain the selected edge 402 | No | 4 |
| | equivalent in the principal occurrence | | |
| | P and the selected occurrence 403 | | |
| | coordinate system | | |
| 212d | Rigidly constrain the other edges in | Yes | 4.1, |
| | the principal occurrence P and the | (for each | 4.2 . . . |
| | selected occurrence 403 coordinate | occurrence) | |
| | system | | |
| 212e | Fixedly constrain the principal | Yes | 5 |
| | occurrence P coordinate system | | |
| 212f | Fixedly constrain the x-axis spacing | Yes | 6 |
| 212f | Fixedly constrain the y-axis spacing | Yes | 7 |

The resulting pattern 400′ is shown in FIG. 4b. Here the upright of the “L”-shape is broadened by the moving of the edge 402, which has been replicated in each of the other occurrences of the shape element 401′ without any changes to the original rectangular pattern.

FIG. 5a is a schematic representation of a second pattern prior to a change being made to an occurrence of a shape element, and FIG. 5b is a schematic representation of a second pattern after a change has been made to an occurrence of a shape element.

In FIG. 5a, the pattern 500 again includes twelve occurrences of a shape element 501 arranged in a four by three pattern uniformly on x- and y-axes. The origin O sits at the lower left-hand corner of the pattern 500. The horizontal spacing along the x-axis is given as 10 size units, and the vertical spacing along the y-axis is also given as 10 size units. The shape element 501 may be “L”-shaped and includes six edges. A user desires to move the pattern diagonally equally in the x- and y-directions, so choses to move the occurrence 502 of the shape element 501 located at the lower right-hand corner of the pattern 500. In order for this move to occur, the method 200 is executed by the data-processing system 10, with the sub-acts in the process for implementing optional behavior characteristics as shown in Table 2 below, where a constraint is imposed if it is required by the change provided by the user. In this example, a change is applied to an occurrence of the shape element that is not the principal occurrence P.

TABLE 2
optional constraints for moving a single
edge in an occurrence of a shape element

| Sub-Act | Optional constraint | Imposed | Order |
|---|---|---|---|
| 212a | Fixedly constrain the x-axis | Yes | 1 |
| 212b | Fixedly constrain the y-axis | Yes | 2 |
| 212c | Fixedly constrain the occurrence coordinate | No | 3 |
| | system of the selected occurrence 502 of | | |
| | the shape element 501 | | |
| 212d | Rigidly constrain the edges equivalent in | Yes | 4 |
| | the principal occurrence P and the selected | | |
| | occurrence 502, and the other edges in the | | |
| | principal occurrence P and the selected | | |
| | occurrence 502 coordinate system | | |
| 212e | Fixedly constrain the principal occurrence | No | 5 |
| | P coordinate system | | |
| 212f | Fixedly constrain the x-axis spacing | Yes | 6 |
| 212f | Fixedly constrain the y-axis spacing | Yes | 7 |

The resulting pattern 500′ is shown in FIG. 5b. Here the entire pattern 500′ has been moved diagonally equally in the x- and y-directions, without any changes to the occurrences of the shape elements 501′, such that the size of each occurrence of the shape element remains the same as the original.

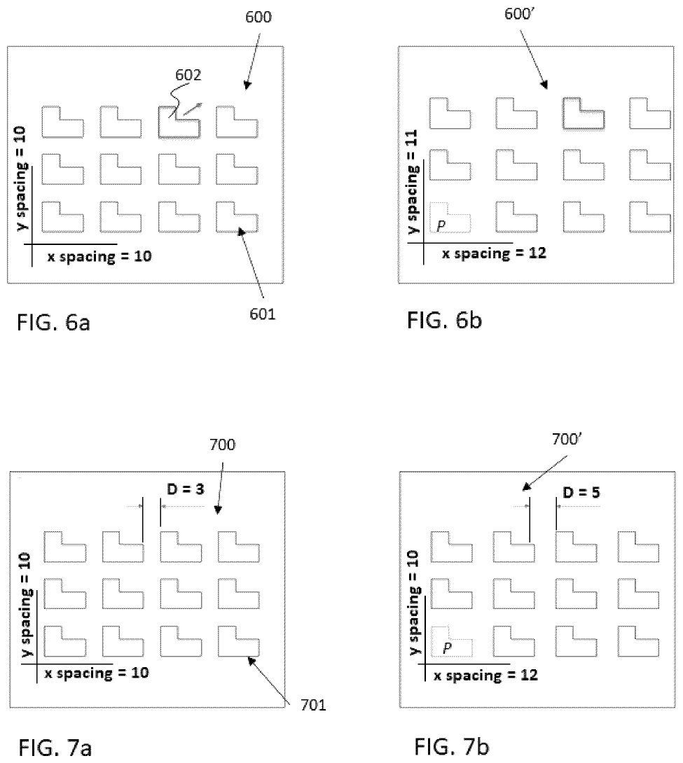

FIG. 6a is a schematic representation of a third pattern prior to a change being made to an occurrence of a shape element, and FIG. 6b is a schematic representation of a third pattern after a change has been made to an occurrence of a shape element.

In FIG. 6a, the pattern 600 again includes twelve occurrences of a shape element 601 arranged in a four by three pattern uniformly on x- and y-axes. The origin O sits at the lower left-hand corner of the pattern 600. The horizontal spacing along the x-axis is given as 10 size units, and the vertical spacing along the y-axis is also given as 10 size units. The shape element 601 may be “L”-shaped and includes six edges. A user desires to expand the pattern diagonally equally in the x- and y-directions without changing the size of each occurrence of the shape element, so choses to move the occurrence 602 of the shape element 601 located at the lower right-hand corner of the pattern 600. In order for this move to occur, the method 200 is executed by the data-processing system 10, with the sub-acts in the process for implementing optional behavior characteristics as shown in Table 3 below, where a constraint is imposed if it is required by the change provided by the user. In this example, a change is applied to an occurrence of the shape element that is not the principal occurrence P.

TABLE 3
optional constraints for moving a single
edge in an occurrence of a shape element

| Sub-Act | Optional constraint | Imposed | Order |
|---|---|---|---|
| 212a | Fixedly constrain the x-axis | Yes | 1 |
| 212b | Fixedly constrain the y-axis | Yes | 2 |
| 212c | Fixedly constrain the occurrence coordinate | No | 3 |
| | system of the selected occurrence 602 of the | | |
| | shape element 601 | | |
| 212d | Rigidly constrain the edges equivalent in the | Yes | 4 |
| | principal occurrence P and the selected | | |
| | occurrence 602, and the other edges in the | | |
| | principal occurrence P and the selected | | |
| | occurrence 602 coordinate system | | |
| 212e | Fixedly constrain the principal occurrence | Yes | 5 |
| | P coordinate system | | |
| 212f | Fixedly constrain the x-axis spacing | No | 6 |
| 212f | Fixedly constrain the y-axis spacing | No | 7 |

The resulting pattern 600′ is shown in FIG. 6b. Here the entire pattern 600′ has been expanded diagonally equally in the x- and y-directions, without any changes to the occurrences of the shape element 601′, such that the size of each occurrence of the shape element remains the same as the original.

FIG. 7a is a schematic representation of a fourth pattern prior to a change being made to an occurrence of a shape element, and FIG. 7b is a schematic representation of a fourth pattern after a change has been made to an occurrence of a shape element.

In FIG. 7a, the pattern 700 again includes twelve occurrences of a shape element 701 arranged in a four by three pattern uniformly on x- and y-axes. The origin O sits at the lower left-hand corner of the pattern 700. The horizontal spacing along the x-axis is given as 10 size units, and the vertical spacing along the y-axis is also given as 10 size units. The shape element 701 may be “L”-shaped and includes six edges. Each occurrence of the shape element 701 is spaced at a distance of D=3 from its adjacent occurrence along the x-axis. A user desires to increase the spacing between each occurrence of the shape element 701 from a distance of D=3 from its adjacent occurrence along the x-axis to a distance of D=5 from the adjacent occurrence along the x-axis This is done by changing the dimension D. In order for this to occur, the method 200 is executed by the data-processing system 10, with the sub-acts in the process for implementing optional behavior characteristics as shown in Table 4 below, where a constraint is imposed if it is required by the change provided by the user. In this example, a change is applied to an occurrence of the shape element that is not the principal occurrence P.

TABLE 4
optional constraints for changing the spacing
between occurrences of a shape element

| Sub-Act | Optional constraint | Imposed | Order |
|---|---|---|---|
| 212a | Fixedly constrain the x-axis | Yes | 1 |
| 212b | Fixedly constrain the y-axis | Yes | 2 |
| 212d | Rigidly constrain the edges equivalent in | Yes | 4.1, |
| | the principal occurrence P and the selected | | 4.2 . . . |
| | occurrence 702, and the other edges in the | | |
| | principal occurrence P and the selected | | |
| | occurrence 702 coordinate system | | |
| 212e | Fixedly constrain the principal occurrence | Yes | 5 |
| | P coordinate system | | |
| 212f | Fixedly constrain the x-axis spacing | No | 6 |
| 212f | Fixedly constrain the y-axis spacing | Yes | 7 |

The resulting pattern 700′ is shown in FIG. 7b. Here the entire pattern 700′ has had the spacing between the occurrences of the shape element increased in the x-direction, while the y-direction spacing and size of each occurrence of the shape element have been maintained as their original values.

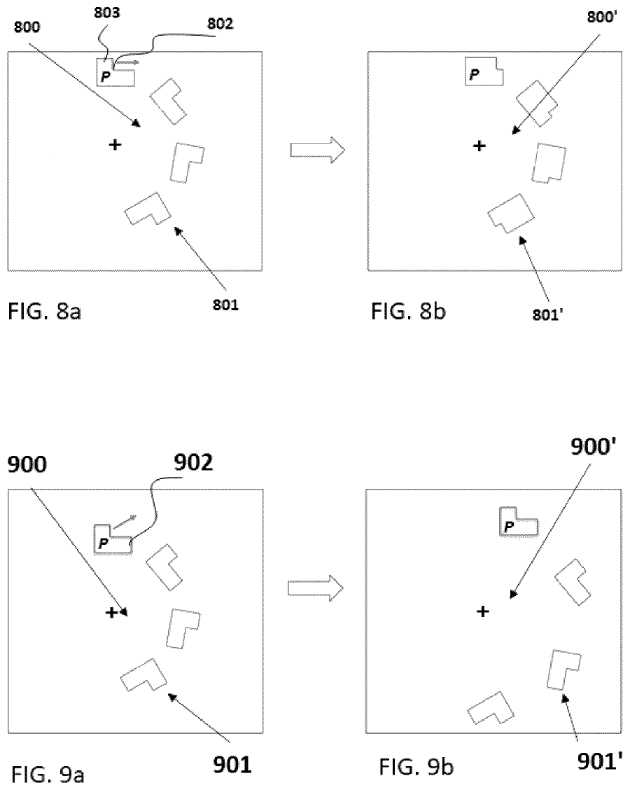

FIG. 8a is a schematic representation of a fifth pattern prior to a change being made to an occurrence of a shape element, and FIG. 8b is a schematic representation of a fifth pattern after a change has been made to an occurrence of a shape element.

In FIG. 8a, the pattern 800 includes four occurrences 801 of a shape element, this time arranged in a circular pattern having a pattern axis at the center of the circle. The shape element 801 may be “L”-shaped and includes six edges. Each occurrence of the shape element 801 arranged around the center of a circle, with the uppermost (at approximately 12 o'clock if the circular pattern is considered as a clock edge) occurrence of the shape element 801 designated as the principal occurrence P. A user desires to move one of the edges 802 of a selected occurrence of a shape element 803 to broaden the upright of the “L”-shape by moving the edge outwards in the direction of the arrow. In order for this to occur, the method 200 is executed by the data-processing system 10, with the sub-acts in the process for implementing optional behavior characteristics as shown in Table 5 below, where a constraint is imposed if it is required by the change provided by the user.

TABLE 5
optional constraints for moving a single
edge in an occurrence of a shape element

| Sub- | | | |
|---|---|---|---|
| Act | Optional constraint | Imposed | Order |
| 212a | Fixedly constrain the pattern axis | Yes | 1 |
| 212b | Fixedly constrain the coordinate system | Yes | 2 |
| | of the selected occurrence of the shape | | |
| | element 803 | | |
| 212c | Rigidly constrain the edge 802 in the | No | 3 |
| | principal occurrence of the shape element | | |
| | P and the coordinate system of the selected | | |
| | occurrence of the shape element 803 | | |
| 212d | Rigidly constrain the other edges in the | Yes | 4.1, |
| | principal occurrence P and the coordinate | | 4.2 . . . |
| | system of the selected occurrence of the | | |
| | shape element 803 | | |
| 212e | Fixedly constrain the distance between the | Yes | 5 |
| | pattern axis and the coordinate system of | | |
| | the principal occurrence of the shape | | |
| | element P | | |
| 212f | Fixedly constrain the coordinate system of | Yes | 6 |
| | the principal occurrence of the shape | | |
| | element P | | |
| 212f | Fixedly constrain the angle between the | Yes | 7 |
| | occurrences of the shape element 801 | | |
| 212f | Fixedly constrain the direction between | Yes | 8 |
| | the pattern axis and the coordinate | | |
| | system of the principal occurrence of the | | |
| | shape element P | | |

The resulting pattern 800′ is shown in FIG. 8b. Here the upright of the “L”-shape is broadened by the moving of the edge 802, which has been replicated in each of the other occurrences of the shape element 801′ without any changes to the original circular pattern.

FIG. 9a is a schematic representation of a sixth pattern prior to a change being made to an occurrence of a shape element, and FIG. 9b is a schematic representation of a sixth pattern after a change has been made to an occurrence of a shape element.

In FIG. 9a, the pattern 900 includes four occurrences 901 of a shape element, this time arranged in a circular pattern having a pattern axis at the center of the circle. The shape element 901 may be “L”-shaped and includes six edges. Each occurrence of the shape element 901 arranged around the center of a circle, with the uppermost (at approximately 12 o'clock if the circular pattern is considered as a clock edge) occurrence of the shape element 901 designated as the principal occurrence P. A user desires to increase the radius of the circular pattern by changing the radius, thus also changing the spacing between the occurrences of the shape element 901 without altering the shape of the occurrences of the shape element 901. This is done by taking the principal occurrence of the shape element P as the selected occurrence of a shape element 902 and moving it outwards away from the pattern axis passing through the center of the circular pattern. In order for this to occur, the method 200 is executed by the data-processing system 10, with the sub-acts in the process for implementing optional behavior characteristics as shown in Table 6 below, where a constraint is imposed if it is required by the change provided by the user.

TABLE 6
optional constraints for expanding a circular
pattern of occurrences of a shape element

| Sub-Act | Optional constraint | Imposed | Order |
|---|---|---|---|
| 212a | Fixedly constrain the pattern axis | Yes | 1 |
| 212b | Fixedly constrain the coordinate system | No | 2 |
| | of the selected occurrence of the shape | | |
| | element 902 | | |
| 212c | Rigidly constrain edges in the principal | Yes | 3 |
| | occurrence of the shape element P | | |
| 212d | Fixedly constrain the distance between | No | 4 |
| | the pattern axis and the coordinate | | |
| | system of the principal occurrence of | | |
| | the shape element P | | |
| 212e | Fixedly constrain the coordinate system | No | 5 |
| | of the principal occurrence of the shape | | |
| | element P | | |
| 212f | Fixedly constrain the angle between the | Yes | 6 |
| | occurrences of the shape element 901 | | |
| 212f | Fixedly constrain the direction between | No | 7 |
| | the pattern axis and the coordinate | | |
| | system of the principal occurrence of the | | |
| | shape element P | | |

The resulting pattern 900′ is shown in FIG. 9b. Here the circular pattern 900′ is maintained with an increased radius, while the actual occurrences of the shape elements 901′ are unaltered.

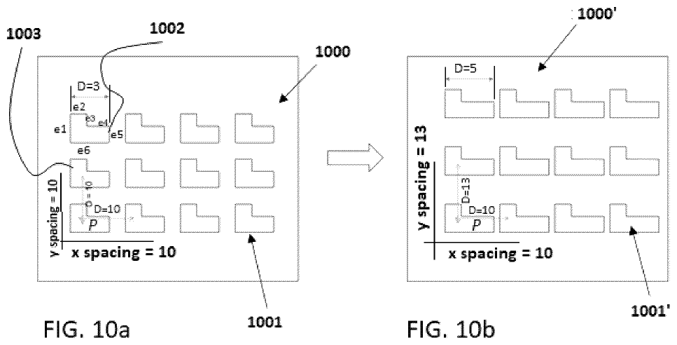

In the examples above only one of the patterns or the size/shape of an occurrence of a shape element is altered. However, it may be desirable to be able to change both the size and shape of an occurrence of a shape element and the pattern by using the relevant optional constraints, as explained below. FIG. 10a is a schematic representation of a seventh pattern prior to a change being made to an occurrence of a shape element, and FIG. 10b is a schematic representation of a seventh pattern after a change has been made to an occurrence of a shape element.

In FIG. 10a, the pattern 1000 includes twelve occurrences 1001 of a shape element, where each shape element 1001 may be “L”-shaped and includes six edges e1-e6. The occurrences 1001 of the shape element are arranged in a rectangular pattern, having an x-axis spacing of 10 size units along the bases of the “L”-shape, ay-axis spacing of 10 size units along the uprights of the “L”-shape and the origin O located at the bottom left-hand corner of the pattern. The occurrence of the shape element 1001 designated as the principal occurrence P. A user desires to increase the length of the base of the “L”-shape of each occurrence of the shape element from D=3 size units to D=5 size units, and to expand the pattern by changing y-axis spacings from 10 size units to 13 size units. This is done by selecting an occurrence 1003 of the shape element positioned at the top left-had corner of the rectangular pattern and moving the edge e5 forming the right-hand end of the base of the “L”-shaped shape element 1001 along the x-axis in a positive direction to increase the length of the base of the “L”-shaped shape element. This occurrence of the shape element 1003 is not the principal occurrence of the shape element P. However, to change the spacing of the pattern along the y-axis, the occurrence of the shape element 1004 adjacent to the principal occurrence of the shape element P along the y-axis is moved in a positive direction along the y-axis. In order for this to occur, the method 200 is executed by the data-processing system 10, with the sub-acts in the process for implementing optional behavior characteristics as shown in Table 7 below, where a constraint is imposed if it is required by the change provided by the user.

TABLE 7
optional constraints for changing both the size
and shape of occurrences of a shape element and
the spacing of the pattern they are arranged in.

| Sub- | | | |
|---|---|---|---|
| Act | Optional constraint | Imposed | Order |
| 212a | Fixedly constrain the x-axis | Yes | 1 |
| 212a | Fixedly constrain the y-axis | yes | 2 |
| 212b | Fixedly constrain the coordinate system | No | 3 |
| | of the selected occurrence 1003 | | |
| 212d | Rigidly constrain the edges e1-e6 in the | e1: yes | 5 |
| | principal occurrence of the shape element | e2: yes | 6 |
| | P and the coordinate system of the | e3: yes | 7 |
| | selected occurrence of the shape element | e4: yes | 8 |
| | 1003 | e5: no | 9 |
| | | e6: yes | 10 |
| 212e | Fixedly constrain the coordinate system | Yes | 11 |
| | of the principal occurrence of the shape | | |
| | element P | | |
| 212f | Fixedly constrain the spacing along the x-axis | Yes | 6 |
| 212f | Fixedly constrain the spacing along the y-axis | No | 7 |

The resulting pattern 1000′ is shown in FIG. 10b. Here the rectangular pattern is shown with an increased y-axis spacing, and the base of the “L”-shape of each occurrence 1001′ of the shape element has increased in size. The ordering of the two operations is carried out based upon the hierarchical definitions of the optional constraints, with the change in the size and shape of the occurrences of the shape element 1001 being carried out before the change in the spacing along the y-axis.

The approach used by the embodiments outlined above provides several advantages over methods used previously. The user does not need to fully constrain the pattern, since intuitive behavior will be provided by the system by default. If the user does constrain the pattern, as the optional constraints will only be applied, when possible, the system will automatically adapt to this by adding the new optional constraints into the system in addition to the unbreakable constraints of the core behavioral characteristics. In addition, the system does not prevent desirable edits for more complex cases, where both the spacing and shape of the occurrences may need to change. By using optional constraints that are implemented only when required and in a strict order, the solver is able to deal with complex user requests for changes, even in detailed models of a variety of engineering products. It is possible to change patterns without affecting the size and shape of an occurrence of a shape element and vice versa easily by providing that constraints are imposed in the same order as the hierarchical order of constraint definitions.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of modelling engineering design components in a Computer-Aided Design (CAD) system, wherein an engineering design component comprises a feature having at least three occurrences of a shape element arranged in a pattern, the method comprising:
defining a core set of geometric characteristics of the at least three occurrences of the shape element in the feature and spatial relationships between the at least three occurrences of the shape element in the pattern, wherein each geometric characteristic and spatial relationship is associated with a constraint determining a behavior of an occurrence of the shape element when changed;
defining a set of optional geometric characteristics of the at least three occurrences of the shape element in the feature and the spatial relationships between the at least three occurrences of the shape element in the pattern, wherein each optional geometric characteristic and spatial relationship is associated with an optional constraint determining the behavior of the occurrence of the shape element when changed;
defining a hierarchical order for the set of optional geometric characteristics and spatial relationships and the associated optional constraints;
receiving a change in the at least three occurrences of the shape element and/or the pattern from a user, the change being carried out by:
solving the constraints associated with the core set of geometric characteristics and spatial relationships; and
solving the optional constraints associated with the set of optional geometric characteristics and spatial relationships in the hierarchical order in which these are defined; and
displaying the changed occurrences of the shape element and/or the pattern to the user.

2. The method of claim 1, wherein, when the change comprises selecting all occurrences of the at least three occurrences, a coordinate system of the occurrence is added to the selection.

3. The method of claim 1, wherein the occurrence of the shape element comprises a boundary, and
wherein the boundary is excluded from a definition of the core set of geometric characteristics and the spatial relationships.

4. The method of claim 1, further comprising:
designating a single occurrence of the shape element in the pattern as a principal occurrence; and
changing a shape or a position of all occurrences of the at least three occurrences by changing a shape or a position of the principal occurrence.

5. The method of claim 4, wherein the hierarchical order of the optional constraints associated with the set of optional geometric characteristics and spatial relationships may be the order of the implementation of the set of optional geometric characteristics and spatial relationships.

6. The method of claim 5, wherein the hierarchical order of the optional constraints associated with the set of optional geometric characteristics and spatial relationships is given by:
maintaining a direction of patterns and/or a center of patterns as a constant;
maintaining the position of the occurrence of the shape element while a shape of the shape element is changed;
maintaining at least a portion of the shape of the occurrence of the shape element;
maintaining a radius of a circular pattern;
maintaining the position of the principal occurrence of the shape element;
maintaining a spacing of a pattern as a constant; and
maintaining the position of an occurrence of a shape element in a circular pattern relative to the center of the circular pattern as a constant.

7. The method of claim 5, wherein the order of implementation of a constraint is determined by its effect on subsequently implemented constraints.

8. The method of claim 1, wherein the at least three occurrences of the shape element and/or the pattern are in two-dimensions.

9. The method of claim 1, wherein the at least three occurrences of the shape element and/or the pattern are in three-dimensions.

10. The method of claim 1, wherein the at least three occurrences of the shape element are mechanical, electrical or thermal components in a product.

11. A computer program containing instructions, which, when executed by a computer, cause the computer to:
define a core set of geometric characteristics of at least three occurrences of a shape element in a feature and spatial relationships between the at least three occurrences of the shape element in a pattern, wherein each geometric characteristic and spatial relationship is associated with a constraint determining a behavior of an occurrence of the shape element when changed;
define a set of optional geometric characteristics of the at least three occurrences of the shape element in the feature and the spatial relationships between the at least three occurrences of the shape element in the pattern, wherein each optional geometric characteristic and spatial relationship is associated with an optional constraint determining the behavior of the occurrence of the shape element when changed;
define a hierarchical order for the set of optional geometric characteristics and spatial relationships and the associated optional constraints;
receive a change in the at least three occurrences of the shape element and/or the pattern from a user, the change being carried out by:
solving the constraints associated with the core set of geometric characteristics and spatial relationships; and
solving the optional constraints associated with the set of optional geometric characteristics and spatial relationships in the hierarchical order in which these are defined; and
display the changed occurrences of the shape element and/or the pattern to the user.

12. A data processing system adapted to model engineering design components in a Computer-Aided Design (CAD) system, wherein an engineering design component comprises a feature having at least three occurrences of a shape element arranged in a pattern, the data processing system comprising:
a data processor configured to:
define a core set of geometric characteristics of the at least three occurrences of the shape element in the feature and spatial relationships between the at least three occurrences of the shape element in the pattern, wherein each geometric characteristic and spatial relationship is associated with a constraint determining a behavior of an occurrence of the shape element when changed;
define a set of optional geometric characteristics of the at least three occurrences of the shape element in the feature and the spatial relationships between the at least three occurrences of the shape element in the pattern, wherein each optional geometric characteristic and spatial relationship is associated with an optional constraint determining the behavior of the occurrence of the shape element when changed;
define a hierarchical order for the set of optional geometric characteristics and spatial relationships and the associated optional constraints;
solve the constraints associated with the core set of geometric characteristics and spatial relationships;
solve the constraints associated with the optional geometric characteristics and spatial relationships in the hierarchical order in which these are defined; and
output the changed occurrences;
a user input device configured to receive a change from a user; and
a display device configured to display the changed occurrences of the shape element and/or the pattern output by the data processor to the user.
